(19) United States
(12) Patent Application Publication
(10) Pub. No.: US 2024/0079737 A1
(43) Pub. Date: Mar. 7, 2024

(54) ELECTRODE ASSEMBLY, ELECTROCHEMICAL APPARATUS, AND ELECTRIC DEVICE

(71) Applicant: Ningde Amperex Technology Limited, Ningde (CN)

(72) Inventor: Enchao HAO, Ningde (CN)

(73) Assignee: Ningde Amperex Technology Limited, Ningde (CN)

(21) Appl. No.: 18/461,748

(22) Filed: Sep. 6, 2023

(30) Foreign Application Priority Data
Sep. 6, 2022 (CN) 202211084419.0

(51) Int. Cl. H01M 50/54; H01M 10/0585; H01M 50/474; H01M 50/486; H01M 50/528

(52) U.S. Cl. CPC H01M 50/54; H01M 10/0585; H01M 50/474; H01M 50/486; H01M 50/528; H01M 10/052

(57) ABSTRACT

An electrode assembly includes a number of positive electrode plates, a number of separators, and a number of negative electrode plates. The positive electrode plates, the separators, and the negative electrode plates are stacked sequentially. The positive electrode plate has an extended first tab portion and second tab portion. The first tab portions of the positive electrode plates are stacked and electrically connected to form a main positive electrode tab, and the second tab portions of the positive electrode plates are stacked and electrically connected to form a backup positive electrode tab. The negative electrode plate has an extended third tab portion and fourth tab portion. The third tab portions of the negative electrode plates are stacked and electrically connected to form a main negative electrode tab, and the fourth tab portions of the negative electrode plates are stacked and electrically connected to form a backup negative electrode tab.

### CROSS REFERENCE TO RELATED APPLICATIONS

The present application claims priority to Chinese Patent application No. CN 202211084419.0 filed in the China National Intellectual Property Administration on Sep. 6, 2022, the entire content of which is hereby incorporated by reference.

### TECHNICAL FIELD

Embodiments of this application relate to the field of energy storage devices, and in particular, to an electrode assembly, an electrochemical apparatus, and an electric device.

### BACKGROUND

Due to advantages such as high energy density, good heat dissipation, high safety, low internal resistance, good internal consistency, and high-power discharging, laminated batteries have been widely used in fields such as mobile electronic devices, electric tools, electric vehicles, and unmanned aerial vehicles. In conventional laminated batteries, each electrode plate is provided with a tab portion, and the tab portions with a same polarity are stacked and welded to form a tab with the corresponding polarity. During manufacturing and daily use (for example, dropping) of a laminated battery, the tab portions of some electrode plates are often broken, preventing the corresponding electrode plates from participating in the charging and discharging processes of the battery, which leads to initial capacity loss and/or capacity loss during cycling of the battery and reduces energy density.

### SUMMARY

For the main technical problem solved by embodiments of this application, an electrode assembly, an electrochemical apparatus, and an electric device are provided, so as to effectively solve the problem of decreased battery capacity caused by tab breakage during production and use of a laminated electrode assembly, increasing capacity of the electrode assembly.

To solve the foregoing technical problem, a first technical solution used in some embodiments of this application is to provide an electrode assembly including a number of positive electrode plates, a number of separators, and a number of negative electrode plates, the positive electrode plates, the separators, and the negative electrode plates being stacked sequentially. Each of the positive electrode plates has an extended first tab portion and second tab portion, the first tab portions of the positive electrode plates are stacked and electrically connected to form a main positive electrode tab, and the second tab portions of the positive electrode plates are stacked and electrically connected to form a backup positive electrode tab. The negative electrode plate has an extended third tab portion and fourth tab portion, the third tab portions of the negative electrode plates are stacked and electrically connected to form a main negative electrode tab, and the fourth tab portions of the negative electrode plates are stacked and electrically connected to form a backup negative electrode tab. The main positive electrode tab is electrically connected in parallel with the backup positive electrode tab, and/or the main negative electrode tab is electrically connected in parallel with the backup negative electrode tab.

In this application, the main positive electrode tab or the main negative electrode tab refers to a tab that is connected to a positive or negative electrode terminal to lead out a positive or negative polarity of the electrode assembly; and the backup positive electrode tab or the backup negative electrode tab refers to a tab that is not directly connected to the positive or negative electrode terminal to lead out the polarity of the electrode assembly, and is mainly used to electrically connect an electrode plate with a broken tab portion to other electrode plates when the main positive electrode tab or the main negative electrode tab is broken, allowing the electrode plate with a broken tab portion to still participate in charging and discharging processes of a battery, increasing capacity of the battery. In this application, the parallel electrical connection between the main positive electrode tab and the backup positive electrode tab refers to electrical connection between the tab portions of the main positive electrode tab and the backup positive electrode tab, such that the current flows through not only the main positive electrode tab but also the backup positive electrode tab in the charging and discharging processes, so as to reduce internal resistance of the electrode assembly and increase a charging rate. The parallel electrical connection between the main negative electrode tab and the backup negative electrode tab is similar to the parallel electrical connection between the main positive electrode tab and the backup positive electrode tab.

Optionally, observed along a stacking direction of the electrode assembly, the first tab portion and the second tab portion are located on a same side edge of the positive electrode plate, and the third tab portion and the fourth tab portion are located on a same side edge of the negative electrode plate.

Optionally, observed along the stacking direction of the electrode assembly, the first tab portion, the second tab portion, the third tab portion, and the fourth tab portion are all located on a same side edge of the electrode assembly.

Optionally, the electrode assembly further includes insulators, the insulators being disposed on surfaces of the backup positive electrode tab and the backup negative electrode tab.

Optionally, the insulator is made of one or more materials of polycarbonate, polyvinyl chloride, polyethylene glycol terephthalate, polystyrene, polyethylene, polytetrafluoroethylene, and acrylic resin.

Optionally, the electrode assembly further includes a first conductive member, the first conductive member being connected to both the main positive electrode tab and the backup positive electrode tab to achieve the parallel electrical connection between the main positive electrode tab and the backup positive electrode tab.

Optionally, the electrode assembly further includes a second conductive member, the second conductive member being connected to both the main negative electrode tab and the backup negative electrode tab to achieve the parallel electrical connection between the main negative electrode tab and the backup negative electrode tab.

Optionally, the main positive electrode tab is directly connected to the backup positive electrode tab to achieve the parallel electrical connection between the main positive electrode tab and the backup positive electrode tab, and/or, the main negative electrode tab is directly connected to the backup negative electrode tab to achieve the parallel electrical connection between the main negative electrode tab and the backup negative electrode tab.

To solve the foregoing technical problem, a second technical solution used in some embodiments of this application is to provide an electrochemical apparatus including a housing, a positive electrode terminal, a negative electrode terminal, an electrolyte, and the electrode assembly according to the first technical solution. The housing is provided with an accommodating cavity, the electrode assembly and the electrolyte are both disposed in the accommodating cavity, the main positive electrode tab is electrically connected to the positive electrode terminal, the main negative electrode tab is electrically connected to the negative electrode terminal, and part of the positive electrode terminal and part of the negative electrode terminal extend out of the housing.

To solve the foregoing technical problem, a third technical solution used in some embodiments of this application is to provide an electric device including the electrochemical apparatus according to the second technical solution.

In some embodiments of this application, the electrode assembly includes a number of positive electrode plates, a number of separators, and a number of negative electrode plates, the positive electrode plates, the separators, and the negative electrode plates being stacked sequentially. The positive electrode plate has an extended first tab portion and second tab portion, the first tab portions of the positive electrode plates are stacked and electrically connected to form a main positive electrode tab, and the second tab portions of the positive electrode plates are stacked and electrically connected to form a backup positive electrode tab, where the main positive electrode tab is electrically connected in parallel with the backup positive electrode tab. The negative electrode plate has an extended third tab portion and fourth tab portion, the third tab portions of the negative electrode plates are stacked and electrically connected to form a main negative electrode tab, and the fourth tab portions of the negative electrode plates are stacked and electrically connected to form a backup negative electrode tab, where the main negative electrode tab is electrically connected in parallel with the backup negative electrode tab. With the backup positive electrode tab and the backup negative electrode tab added in the electrode assembly, when the main positive electrode tab and/or the main negative electrode tab is broken during manufacturing or use, the corresponding electrode plate can participate in electrochemical reactions through the backup positive electrode tab and/or the backup negative electrode tab, which can effectively solve the problem of decreased battery capacity caused by tab breakage of the electrode assembly, increasing capacity of the electrochemical apparatus.

### BRIEF DESCRIPTION OF DRAWINGS

To describe the technical solutions in specific embodiments of this application or in the prior art more clearly, the following briefly describes the accompanying drawings required for describing the specific embodiments or the prior art. In all the accompanying drawings, similar elements or portions are generally marked by similar reference signs. In the accompanying drawings, the elements or portions are not necessarily drawn to scale.

FIG. 1 is a schematic cross-sectional view of an electrochemical apparatus according to an embodiment of this application.

FIG. 2 is a schematic diagram of an electrode assembly according to an embodiment of this application from one perspective.

FIG. 3 is an exploded view of an electrode assembly according to an embodiment of this application from one perspective.

FIG. 4 is a schematic diagram of a current flow direction of a normal electrode assembly according to an embodiment of this application.

FIG. 5 is a schematic diagram of a current flow direction of an electrode assembly with some tab portions being broken according to an embodiment of this application.

FIG. 6 is a schematic diagram of a positive electrode plate of an electrode assembly according to another embodiment of this application.

FIG. 7 is a schematic diagram of a positive electrode plate of an electrode assembly according to still another embodiment of this application.

FIG. 8 is a schematic diagram of an electrode assembly according to an embodiment of this application from another perspective.

FIG. 9 is a schematic diagram of a main negative electrode tab being directly connected to a backup negative electrode tab in an electrode assembly according to an embodiment of this application.

FIG. 10 is a schematic diagram of a main negative electrode tab being connected to a backup negative electrode tab through a conductive member in an electrode assembly according to an embodiment of this application.

FIG. 11 is a schematic diagram of a main negative electrode tab being connected to a backup negative electrode tab through another conductive member in an electrode assembly according to an embodiment of this application.

FIG. 12 is a schematic diagram showing test results of electrode assemblies according to an embodiment of this application.

### DETAILED DESCRIPTION

For ease of understanding this application, the following further describes this application in detail with reference to the accompanying drawings and specific embodiments. It should be noted that when an element is referred to as being “fixed to” another element, it may be directly fixed to the another element, or there may be one or more elements therebetween. When an element is referred to as being “connected to” another element, it may be directly connected to the another element, or there may be one or more elements therebetween. The orientations or positional relationships indicated by the terms “upper”, “lower”, “inside”, “outside”, “perpendicular”, “horizontal”, and the like used herein are based on the orientations or positional relationships shown in the accompanying drawings. These terms are merely for ease and brevity of description of this application rather than indicating or implying that the apparatuses or elements mentioned must have specific orientations or must be constructed or manipulated according to specific orientations, and therefore shall not be construed as any limitations on this application. In addition, the terms “first”, “second”, and the like are merely for the purpose of description and shall not be understood as any indication or implication of relative importance.

Unless otherwise defined, all technical and scientific terms used herein shall have the same meanings as commonly understood by persons skilled in the art to which this application belongs. The terms used in the specification of this application are for description of specific embodiments only without any intention to limit this application. The term “and/or” used herein includes any and all combinations of one or more associated items listed.

In addition, technical features involved in different embodiments of this application that are described below may be combined as long as they do not conflict with each other.

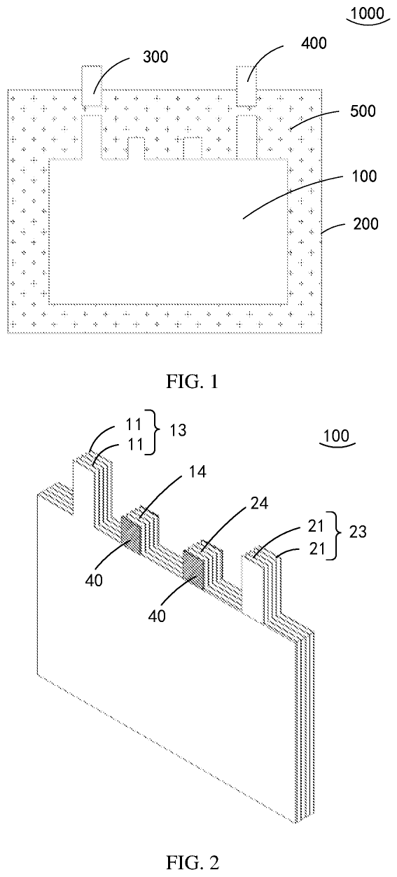

Referring to FIG. 1 and FIG. 2, this application provides an embodiment of an electrochemical apparatus 1000. The electrochemical apparatus 1000 includes an electrode assembly 100, a housing 200, a positive electrode terminal 300, a negative electrode terminal 400, and an electrolyte 500. The housing 200 is provided with an accommodating cavity, and the electrode assembly 100 and the electrolyte 500 are both disposed in the accommodating cavity. The electrode assembly 100 has an extended main positive electrode tab 13 and main negative electrode tab 23, the main positive electrode tab 13 is electrically connected to the positive electrode terminal 300, the main negative electrode tab 23 is electrically connected to the negative electrode terminal 400, the positive electrode terminal 300 forms a positive electrode of the electrochemical apparatus 1000, and the negative electrode terminal 400 forms a negative electrode of the electrochemical apparatus 1000. It is worth noting that FIG. 1 is only a simple schematic diagram for ease of description of the structure of the electrochemical apparatus 1000. The positive electrode terminal 300 and/or the negative electrode terminal 400 may be a pole that is electrically insulated from the housing 200 and that partially extends out of the housing 200. The positive electrode terminal 300 and/or the negative electrode terminal 400 may alternatively be part of the housing 200, meaning that the main positive electrode tab 13 and/or the main negative electrode tab 23 may be directly electrically connected to the housing 200, such that the housing 200 has the corresponding polarity. These are common ways of leading out polarity of electrode assembly known to persons skilled in the art. In addition, this application does not exclude other ways of leading out polarity of electrode assembly well known in the art, provided that the polarities of the main positive electrode tab 13 and the main negative electrode tab 23 can be led out.

In some embodiments, the housing 200 may be made of metal, metal alloy, aluminum-plastic film, plastic, or the like.

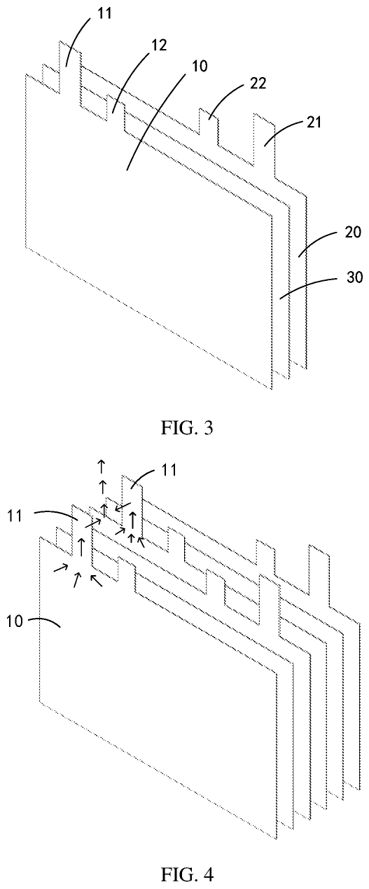

For the electrode assembly 100, referring to FIG. 2 and FIG. 3, the electrode assembly 100 includes a number of positive electrode plates 10, a number of negative electrode plates 20, and a number of separators 30. The positive electrode plates 10 and the negative electrode plates 20 are stacked sequentially and alternately, and the separator 30 is disposed between an adjacent positive electrode plate 10 and negative electrode plate 20. Each of the positive electrode plates 10 has an extended first tab portion 11 and second tab portion 12, the first tab portions 11 of the positive electrode plates 10 are stacked and electrically connected to form a main positive electrode tab 13, and the second tab portions 12 of the positive electrode plates 10 are stacked and electrically connected to form a backup positive electrode tab 14. Each of the negative electrode plates 20 has an extended third tab portion 21 and fourth tab portion 22, the third tab portions 21 of the negative electrode plates 20 are stacked and electrically connected to form a main negative electrode tab 23, and the fourth tab portions 22 of the negative electrode plates 20 are stacked and electrically connected to form a backup negative electrode tab 24. The main positive electrode tab 13 is electrically connected in parallel with the backup positive electrode tab 14, and/or the main negative electrode tab 23 is electrically connected in parallel with the backup negative electrode tab 24. The parallel electrical connection specifically refers to electrical connection between the tab portions of the main positive electrode tab 13 and the backup positive electrode tab 14, such that the current flows through not only the main positive electrode tab 13 but also the backup positive electrode tab 14 in charging and discharging processes. Similarly, electrical connection between the tab portions of the main negative electrode tab 23 and the backup negative electrode tab 24 allows the current to flow through not only the main negative electrode tab 23 but also the backup negative electrode tab 24 in the charging and discharging processes. The main positive electrode tab 13 is electrically connected in parallel with the backup positive electrode tab 14, and/or the main negative electrode tab 23 is electrically connected in parallel with the backup negative electrode tab 24. Such arrangement can reduce internal resistance of the electrode assembly 100 and effectively increase a charging rate of the electrode assembly 100.

In some embodiments, after being stacked, a number of second tab portions 12 may be electrically connected to form the backup positive electrode tab 14 by ultrasonic welding, laser welding, or bonding with conductive binder. After being stacked, a number of fourth tab portions 22 may be electrically connected to form the backup negative electrode tab 24 by ultrasonic welding, laser welding, or bonding with conductive binder. The ultrasonic welding employs an ultrasonic welding pressure ranging from 0.05 MPa to 0.3 MPa, an amplitude ranging from 30% to 90%, and a welding energy ranging from 5 J to 200 J, with an effective ultrasonic welding residual area greater than or equal to 50% of welding region. Parameters of the laser welding are set as follows: laser power ranges from 50% to 100%, laser pulse width ranges from 0 ms to 50 ms, and laser welding speed ranges from 50 mm/s to 500 mm/s.

In some embodiments of this application, both the first tab portion 11 and the second tab portion 12 of the positive electrode plate 10 are integrally formed with the positive electrode plate 10 and then subjected to secondary processing and cutting. The integrally formed structure can reduce internal resistance between the first tab portion 11 and second tab portion 12 and the positive electrode plate 10, thereby reducing energy loss of the current and thickness of the electrode assembly, improving energy density of the battery. It can be understood that in some other embodiments, the first tab portion 11 and/or the second tab portion 12 may be fixed to the positive electrode plate 10 by welding, bonding with conductive adhesive, or the like.

In some embodiments of this application, both the third tab portion 21 and the fourth tab portion 22 of the negative electrode plate 20 are integrally formed with the negative electrode plate 20 and then subjected to secondary processing and cutting. The integrally formed structure can reduce internal resistance between the third tab portion 21 and fourth tab portion 22 and the negative electrode plate 20, thereby reducing energy loss of the current and thickness of the electrode assembly, improving the energy density of the battery. It can be understood that in some other embodiments, the third tab portion 21 and/or the fourth tab portion 22 may be fixed to the negative electrode plate 20 by welding, bonding with conductive adhesive, or the like.

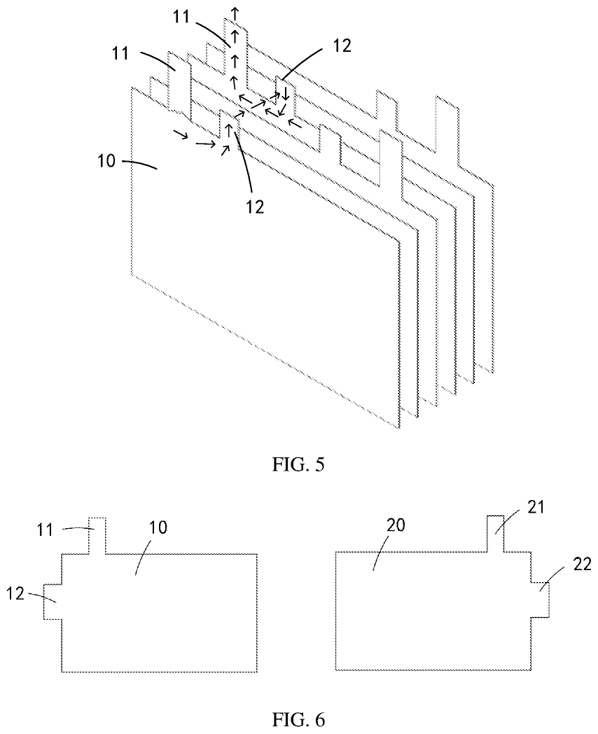

For the positive electrode plate 10 and the negative electrode plate 20, still refer to FIG. 3 to FIG. 5, where the arrows in the figures indicate current flow directions. Observed along a stacking direction of the positive electrode plate 10 and the negative electrode plate 20 in the electrode assembly 100, the first tab portion 11 and the second tab portion 12 are located on a same side of the positive electrode plate 10, and the third tab portion 21 and the fourth tab portion 22 are located on a same side of the negative electrode plate 20. The main positive electrode tab 13 jointly formed by a number of first tab portions 11 is welded to the positive electrode terminal 300. When the electrochemical apparatus 1000 is experiencing vibration or severe impact, the electrode assembly 100 moves relative to the housing 200, and a number of first tab portions 11 in the main positive electrode tab 13 are prone to breakage and separate from the corresponding positive electrode plates 10. Therefore, when the electrochemical apparatus 1000 is in a discharge state, the current on the broken positive electrode plates 10 cannot directly flow to the positive electrode terminal 300 through the first tab portions 11, but flows to the positive electrode terminal 300 through the corresponding second tab portions 12, other positive electrode plates 10 and second tab portions 12 connected thereto, and then first tab portions 11 on other positive electrode plates 10. After the third tab portions 21 on the negative electrode plates 20 are separate from the negative electrode plates 20, a current flow direction on the negative electrode plates 20 is similar. Details are not described herein again. In addition, when the electrochemical apparatus 1000 is in a charge state, it is similar to the foregoing description, but only the current flow direction is reversed. Details are not described herein again. The backup positive electrode tab is electrically connected in parallel with the main positive electrode tab, and the backup negative electrode tab is electrically connected in parallel with the main negative electrode tab. Such arrangement can allow the electrode plate with a broken main tab to still participate in the charging and discharging processes of the battery, increasing capacity of the battery.

After the main tab is broken, the current needs to be transferred through the backup tab of the electrode plate, meaning that the current needs to flow through main tabs and backup tabs of different electrode plates. Therefore, it is preferred to dispose the first tab portion 11 and the second tab portion 12 on a same side of the positive electrode plate 10, and the third tab portion 21 and the fourth tab portion 22 on a same side of the negative electrode plate 20. This can effectively shorten a flow path of the current on the positive electrode plate 10 and the negative electrode plate 20, and reduce the internal resistance, thus reducing current loss.

After a number of positive electrode plates 10, a number of separators 30, and a number of negative electrode plates 20 are stacked sequentially, observed along the stacking direction of the positive electrode plate 10 and the negative electrode plate 20 in the electrode assembly 100, the first tab portion 11, the second tab portion 12, the third tab portion 21, and the fourth tab portion 22 are all located on a same side edge of the electrode assembly 100. The first tab portion 11 protrudes out of the positive electrode plate 10, and the third tab portion 21 protrudes out of the negative electrode plate 20. Therefore, a corresponding space needs to be reserved inside the housing 200 for the main positive electrode tab 13 to be welded to the positive electrode terminal 300 and the main negative electrode tab 23 to be welded to the negative electrode terminal 400. The second tab portion 12 and the fourth tab portion 22 are also disposed on the same side of the electrode assembly 100, meaning that all the tab portions of the electrode assembly 100 are located on the same side and can use the same space. This prevents increased volume of the housing 200 or reduced space utilization of the accommodating cavity caused by the backup positive electrode tab 14 formed by a number of second tab portions 12 and the backup negative electrode tab 24 formed by a number of fourth tab portions 22 being disposed on other side edges of the electrode assembly 100 and needing to occupy additional space of the accommodating cavity inside the housing 200.

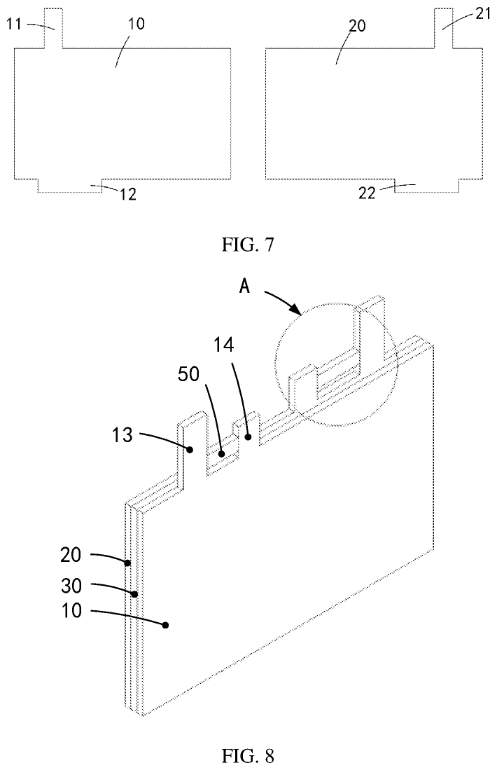

Certainly, it can be understood that in some other embodiments, referring to FIG. 6 and FIG. 7, based on shape, size, production requirements, and the like of the electrochemical apparatus, the first tab portion 11 and the second tab portion 12 may be disposed on two adjacent side edges or two opposite side edges of the positive electrode plate 10, and the third tab portion 21 and the fourth tab portion 22 may be disposed on two adjacent side edges or two opposite side edges of the negative electrode plate 20.

In some embodiments, referring to FIG. 2, the electrode assembly 100 further includes insulators 40, the insulators 40 being disposed on surfaces of the backup positive electrode tab 14 and the backup negative electrode tab 24. The insulator 40 is configured to electrically insulate the backup positive electrode tab 14 and the backup negative electrode tab 24 from the housing 200, preventing a short circuit between the backup positive electrode tab 14 or the backup negative electrode tab 24 and the housing 200. The insulator 40 may be made of one or more materials of polycarbonate, polyvinyl chloride, polyethylene glycol terephthalate, polystyrene, polyethylene, polytetrafluoroethylene, and acrylic resin.

The insulator 40 has the characteristics of resistance to corrosion and immersion of the electrolyte 500, and an initial adhesion force of the insulator 40 is greater than or equal to 0.1 N/mm, so as to improve stability and safety of the electrochemical apparatus 1000 during use.

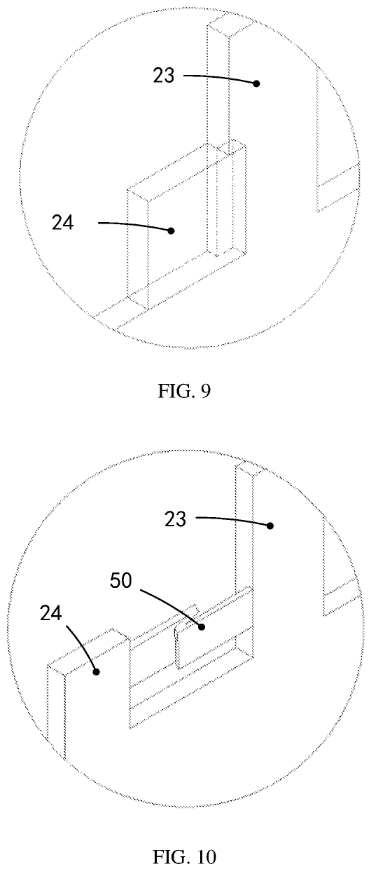

In some embodiments, referring to FIG. 8 and FIG. 9, due to high resistance of the electrode plates, to further reduce the internal resistance of the electrode assembly 100, the main positive electrode tab 13 can be directly connected to the backup positive electrode tab 14, and the main negative electrode tab 23 can be directly connected to the backup negative electrode tab 24. In other words, the main positive electrode tab 13 is directly welded or bonded to the backup positive electrode tab 14 to achieve the parallel electrical connection between the main positive electrode tab 13 and the backup positive electrode tab 14, and/or, the main negative electrode tab 23 is directly welded or bonded to the backup negative electrode tab 24 to achieve the parallel electrical connection between the main negative electrode tab 23 and the backup negative electrode tab 24. In some embodiments, the main positive electrode tab 13 and the backup positive electrode tab 14 may have a partially overlapping region. The partially overlapping region allows for relative movement between the main positive electrode tab 13 and the backup positive electrode tab 14, ensuring that even when the electrode assembly 100 moves relative to the housing 200, the main positive electrode tab 13 and the backup positive electrode tab 14 can always maintain the electrical connection.

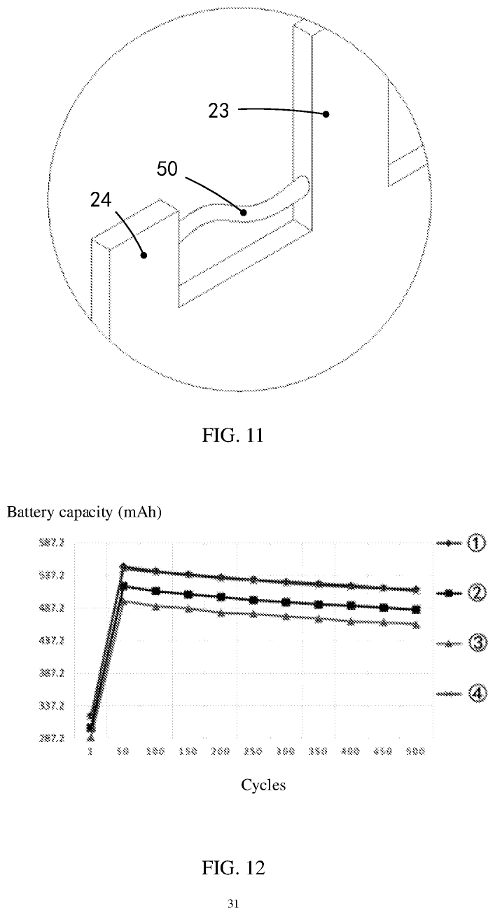

In some embodiments, referring to FIG. 10 and FIG. 11, to further reduce the internal resistance of the electrode assembly 100, the electrode assembly 100 further includes a first conductive member 50, the first conductive member 50 being connected to both the main positive electrode tab 13 and the backup positive electrode tab 14 to achieve the parallel electrical connection between the main positive electrode tab 13 and the backup positive electrode tab 14. It can be understood that in some embodiments, the first conductive member 50 may have a certain expansion amount, which avoids pulling the backup positive electrode tab 14 by the main positive electrode tab 13 that is experiencing vibration or impact when rigid connection is formed between the main positive electrode tab 13 and the backup positive electrode tab 14 as well as between the main negative electrode tab 23 and the backup negative electrode tab 24. For example, the first conductive member 50 is an S-shaped bent conductive sheet or a flexible conductive wire. Similarly, there may be a second conductive member (not shown in the figure) between the main negative electrode tab 23 and the backup negative electrode tab 24 to achieve the parallel electrical connection between the main negative electrode tab 23 and the backup negative electrode tab 24.

Only the main positive electrode tab 13 is welded to the positive electrode terminal 300 and the main negative electrode tab 23 is welded to the negative electrode terminal 400, while the backup positive electrode tab 14 is not welded to the positive electrode terminal 300 and the backup negative electrode tab 24 is not welded to the negative electrode terminal 400. Therefore, when the electrochemical apparatus 1000 is experiencing vibration or severe impact, the electrode assembly 100 moves relative to the housing 200, and the possibility of the second tab portions 12 in the backup positive electrode tab 14 being separate from the positive electrode plate 10 is much lower than the possibility of the first tab portions 11 in the main positive electrode tab 13 being separate from the positive electrode plate 10. Similarly, the possibility of the fourth tab portions 22 in the backup negative electrode tab 24 being separate from the negative electrode plate 20 is much lower than the possibility of the third tab portions 21 in the main negative electrode tab 23 being separate from the negative electrode plate 20. This effectively improves reliability of the electrode assembly 100 and increases capacity of the electrochemical apparatus 1000.

In some embodiments of this application, the electrode assembly 100 includes a number of positive electrode plates 10, a number of separators 30, and a number of negative electrode plates 20, the positive electrode plates 10, the separators 30, and the negative electrode plates 20 being stacked sequentially. The positive electrode plate 10 has an extended first tab portion 11 and second tab portion 12, the first tab portions 11 of the positive electrode plates 10 are stacked and electrically connected to form a main positive electrode tab 13, and the second tab portions 12 of the positive electrode plates 10 are stacked and electrically connected to form a backup positive electrode tab 14. The negative electrode plate 20 has an extended third tab portion 21 and fourth tab portion 22, the third tab portions 21 of the negative electrode plates 20 are stacked and electrically connected to form a main negative electrode tab 23, and the fourth tab portions 22 of the negative electrode plates 20 are stacked and electrically connected to form a backup negative electrode tab 24. The arrangement of adding the backup positive electrode tab 14 and the backup negative electrode tab 24 in the electrode assembly 100 can effectively solve the problem of decreased battery capacity caused by tab breakage of the electrode assembly 100 in special cases, increasing the capacity of the electrochemical apparatus.

To make it easier for readers to understand the technical solutions and technical effects of the electrochemical apparatus in some embodiments of this application, the following uses laminated batteries as an example for test.

### Comparative Example 1

Positive electrode plate: The main materials of the positive electrode plate were lithium cobalt oxide, binder PVDF (polyvinylidene fluoride), and conductive agent acetylene black, and the positive electrode plate had an extended first tab portion.

Negative electrode plate: The main materials of the negative electrode plate were graphite, binder CMC (carboxymethyl cellulose), and conductive agent acetylene black, and the negative electrode plate had an extended third tab portion.

Separator: The main component of the separator was PE (polyethylene).

Electrolyte: The main components of the electrolyte were LiPF₆ (lithium hexafluorophosphate) and a solvent of DMC (dimethyl carbonate) and EC (ethyl cellulose) which were mixed at 1:1.

Electrode assembly: 20 positive electrode plates, 20 negative electrode plates, and a number of separators were taken, and then stacked alternately in an order of positive electrode plate, separator, and negative electrode plate. A separator was disposed between one positive electrode plate and one negative electrode plate. The first tab portions of the positive electrode plates were stacked and welded to form a positive electrode tab, and the third tab portions of the negative electrode plates were stacked and welded to form a negative electrode tab.

### Comparative Example 2

Different from Comparative Example 1, a first tab portion of one positive electrode plate in the electrode assembly was artificially cut.

### Comparative Example 3

Different from Comparative Example 1, first tab portions of two positive electrode plates in the electrode assembly were artificially cut.

### Example 1

Different from Comparative Example 3, the positive electrode plate further had an extended second tab portion, and the negative electrode plate further had an extended fourth tab portion. After the second tab portions and the fourth tab portions were stacked and welded respectively, the second tab portions formed a backup positive electrode tab, and the fourth tab portions formed a backup negative electrode tab.

Test Procedure:

The electrode assembly was first left standing for 5 min, charged to 4.45 V at a constant current of 500 mA, and charged to a cut-off current of 25 mA at a constant voltage; and then left standing for 5 min, and discharged to 3 V at a constant current of 500 mA, to complete one charge and discharge cycle. 500 such charge and discharge cycles were conducted.

Test Results:

As shown in FIG. 12 and Table 1 (Table 1 gives the raw data of the curves in FIG. 12), fold line \textcircled{1} indicates battery capacity changes during cycling of a normal and conventional laminated battery represented by Comparative Example 1; fold line \textcircled{2} indicates battery capacity changes during cycling of a laminated battery with one first tab portion artificially cut; fold line \textcircled{3} indicates battery capacity changes during cycling of a laminated battery with two first tab portions artificially cut; and fold line \textcircled{4} indicates battery capacity changes during cycling of a laminated battery represented by Example 1 of this application with two first tab portions artificially cut and having a backup positive electrode tab and a backup negative electrode tab.

TABLE 1
Battery capacity (mAh)

| | Cycles | | | | | | | | | | |
|---|---|---|---|---|---|---|---|---|---|---|---|
| | 1 | 50 | 100 | 150 | 200 | 250 | 300 | 350 | 400 | 450 | 500 |
| Comparative | 322.582 | 551.076 | 543.825 | 539.141 | 534.558 | 530.73 | 527.461 | 524.678 | 522.017 | 518.36 | 516.103 |
| Example 1 | | | | | | | | | | | |
| Comparativ | 304.122 | 521.052 | 513.296 | 508.323 | 504.367 | 499.558 | 496.263 | 492.823 | 491.223 | 488.001 | 484.946 |
| Example 2 | | | | | | | | | | | |
| Comparativ | 289.1934 | 498.1606 | 490.038 | 486.6774 | 480.2226 | 478.5784 | 474.477 | 471.2613 | 467.0538 | 465.5742 | 462.2856 |
| Example 3 | | | | | | | | | | | |
| Example 1 | 321.017 | 547.23 | 542.375 | 537.803 | 532.995 | 529.704 | 525.609 | 522.527 | 519.575 | 517.341 | 513.216 |

It can be learned from comparison of Comparative Examples 1 to 3 that after a tab of the laminated battery is broken, the battery capacity is significantly decreased, and more tabs being broken means more significant capacity decrease. For Comparative Example 1, Comparative Example 2, and Comparative Example 3, at the same number of cycles, the battery capacity decreases by about 5.4%-6.1% and 9.6%-10% respectively. It can be learned from comparison between Example 1 and Comparative Examples 1 to 3 that after the backup positive and negative electrode tabs are disposed, even if two first tab portions are cut, at the same number of cycles, the battery capacity in Example 1 is significantly higher than that in Comparative Example 3 and also significantly higher than that in Comparative Example 2. Only because the internal resistance of the battery in Example 1 is slightly higher than that of the battery in Comparative Example 1 (in Comparative Example 1, the current directly reaches the electrode plates through the tabs on the electrode plates, while in Example 1, the current reaches the electrode plates with tab breakage through the electrode plates without tab breakage and the backup tabs, which leads to a longer current flow path, so the internal resistance in Example 1 is slightly higher than that in Comparative Example 1), the battery capacity in Example 1 decreases by only about 0.2%-0.7%.

In conclusion, adding the backup positive electrode tab formed by the second tab portions can effectively prevent a sharp decrease in the capacity of the electrochemical apparatus when the electrochemical apparatus is experiencing extreme situations such as vibration or impact, effectively improving the stability of the electrochemical apparatus during use.

This application further provides an embodiment of an electric device. The electric device includes the foregoing electrochemical apparatus and other electric components and electric parts. The electrochemical apparatus is configured to supply electric energy to the electric components and electric parts.

The foregoing descriptions are merely some embodiments of this application, but are not intended to limit the patent scope of this application. Any equivalent structural or process transformation made based on the content of the specification and accompanying drawings of this application and any direct or indirect use of this application in other related technical fields shall all fall within the patent protection scope of this application in the same way.

What is claimed is:

1. An electrode assembly, comprising a plurality of positive electrode plates, a plurality of separators, and a plurality of negative electrode plates; the plurality of positive electrode plates, the plurality of separators, and the plurality of negative electrode plates are stacked together; wherein
each positive electrode plate has a first tab portion and a second tab portion, the first tab portions of the plurality of positive electrode plates are stacked and electrically connected to form a main positive electrode tab, and the second tab portions of the plurality of positive electrode plates are stacked and electrically connected to form a backup positive electrode tab; and
each negative electrode plate has a third tab portion and a fourth tab portion, the third tab portions of the plurality of negative electrode plates are stacked and electrically connected to form a main negative electrode tab, and the fourth tab portions of the plurality of negative electrode plates are stacked and electrically connected to form a backup negative electrode tab; wherein
the main positive electrode tab is electrically connected in parallel with the backup positive electrode tab, and the main negative electrode tab is electrically connected in parallel with the backup negative electrode tab.

2. The electrode assembly according to claim 1, wherein
viewed along a stacking direction of the electrode assembly, the first tab portion and the second tab portion are located on a same side edge of the each positive electrode plate, and the third tab portion and the fourth tab portion are located on a same side edge of the each negative electrode plate.

3. The electrode assembly according to claim 2, wherein
viewed along the stacking direction of the electrode assembly, the first tab portion, the second tab portion, the third tab portion, and the fourth tab portion are all located on a same side edge of the electrode assembly.

4. The electrode assembly according to claim 1, wherein
the electrode assembly further comprises insulators, the insulators being disposed on surfaces of the backup positive electrode tab and the backup negative electrode tab.

5. The electrode assembly according to claim 4, wherein
the insulators are made of one or more materials selected from the group consisting of polycarbonate, polyvinyl chloride, polyethylene glycol terephthalate, polystyrene, polyethylene, polytetrafluoroethylene, and acrylic resin.

6. The electrode assembly according to claim 1, wherein
the electrode assembly further comprises a first conductive member, the first conductive member being connected to both the main positive electrode tab and the backup positive electrode tab to achieve the parallel electrical connection between the main positive electrode tab and the backup positive electrode tab.

7. The electrode assembly according to claim 1, wherein
the electrode assembly further comprises a second conductive member, the second conductive member being connected to both the main negative electrode tab and the backup negative electrode tab to achieve the parallel electrical connection between the main negative electrode tab and the backup negative electrode tab.

8. The electrode assembly according to claim 1, wherein
the main positive electrode tab is directly connected to the backup positive electrode tab to achieve the parallel electrical connection between the main positive electrode tab and the backup positive electrode tab.

9. The electrode assembly according to claim 1, wherein
the main negative electrode tab is directly connected to the backup negative electrode tab to achieve the parallel electrical connection between the main negative electrode tab and the backup negative electrode tab.

10. An electrochemical apparatus, comprising a housing, a positive electrode terminal, a negative electrode terminal, an electrolyte, wherein
the electrode assembly, comprising a plurality of positive electrode plates, a plurality of separators, and a plurality of negative electrode plates; the plurality of positive electrode plates, the plurality of separators, and the plurality of negative electrode plates are stacked together; wherein
each positive electrode plate has a first tab portion and a second tab portion, the first tab portions of the plurality of positive electrode plates are stacked and electrically connected to form a main positive electrode tab, and the second tab portions of the plurality of positive electrode plates are stacked and electrically connected to form a backup positive electrode tab; and
each negative electrode plate has a third tab portion and a fourth tab portion, the third tab portions of the plurality of negative electrode plates are stacked and electrically connected to form a main negative electrode tab, and the fourth tab portions of the plurality of negative electrode plates are stacked and electrically connected to form a backup negative electrode tab; wherein
the main positive electrode tab is electrically connected in parallel with the backup positive electrode tab, and the main negative electrode tab is electrically connected in parallel with the backup negative electrode tab.
the housing is provided with an accommodating cavity, the electrode assembly and the electrolyte are both disposed in the accommodating cavity, the main positive electrode tab is electrically connected to the positive electrode terminal, the main negative electrode tab is electrically connected to the negative electrode terminal, and a part of the positive electrode terminal and a part of the negative electrode terminal extend out of the housing.

11. The electrochemical apparatus according to claim 10, wherein
viewed along a stacking direction of the electrode assembly, the first tab portion and the second tab portion are located on a same side edge of the each positive electrode plate, and the third tab portion and the fourth tab portion are located on a same side edge of the each negative electrode plate.

12. The electrochemical apparatus according to claim 11, wherein
viewed along the stacking direction of the electrode assembly, the first tab portion, the second tab portion, the third tab portion, and the fourth tab portion are all located on a same side edge of the electrode assembly.

13. The electrochemical apparatus according to claim 10, wherein
the electrode assembly further comprises insulators, the insulators being disposed on surfaces of the backup positive electrode tab and the backup negative electrode tab.

14. The electrochemical apparatus according to claim 10, wherein
the insulators are made of one or more materials selected from the group consisting of polycarbonate, polyvinyl chloride, polyethylene glycol terephthalate, polystyrene, polyethylene, polytetrafluoroethylene, and acrylic resin.

15. The electrochemical apparatus according to claim 10, wherein
the electrode assembly further comprises a first conductive member, the first conductive member being connected to both the main positive electrode tab and the backup positive electrode tab to achieve the parallel electrical connection between the main positive electrode tab and the backup positive electrode tab.

16. An electric device, comprising an electrochemical apparatus, the electrochemical apparatus, comprising a housing, a positive electrode terminal, a negative electrode terminal, an electrolyte, wherein
the electrode assembly, comprising a number of positive electrode plates, a number of separators, and a number of negative electrode plates, the positive electrode plates, the separators, and the negative electrode plates being stacked sequentially, wherein
each of the positive electrode plates has an extended first tab portion and second tab portion, the first tab portions of the positive electrode plates are stacked and electrically connected to form a main positive electrode tab, and the second tab portions of the positive electrode plates are stacked and electrically connected to form a backup positive electrode tab; and
each of the negative electrode plates has an extended third tab portion and fourth tab portion, the third tab portions of the negative electrode plates are stacked and electrically connected to form a main negative electrode tab, and the fourth tab portions of the negative electrode plates are stacked and electrically connected to form a backup negative electrode tab; wherein
the main positive electrode tab is electrically connected in parallel with the backup positive electrode tab, and/or the main negative electrode tab is electrically connected in parallel with the backup negative electrode tab;
the housing is provided with an accommodating cavity, the electrode assembly and the electrolyte are both disposed in the accommodating cavity, the main positive electrode tab is electrically connected to the positive electrode terminal, the main negative electrode tab is electrically connected to the negative electrode terminal, and part of the positive electrode terminal and part of the negative electrode terminal extend out of the housing.

17. The electric device according to claim 16, wherein
viewed along a stacking direction of the electrode assembly, the first tab portion and the second tab portion are located on a same side edge of the each positive electrode plate, and the third tab portion and the fourth tab portion are located on a same side edge of the each negative electrode plate.

18. The electric device according to claim 17, wherein
viewed along the stacking direction of the electrode assembly, the first tab portion, the second tab portion, the third tab portion, and the fourth tab portion are all located on a same side edge of the electrode assembly.

19. The electric device according to claim 16, wherein
the electrode assembly further comprises insulators, the insulators being disposed on surfaces of the backup positive electrode tab and the backup negative electrode tab.

20. The electric device according to claim 16, wherein
the insulators are made of one or more materials selected from the group consisting of polycarbonate, polyvinyl chloride, polyethylene glycol terephthalate, polystyrene, polyethylene, polytetrafluoroethylene, and acrylic resin.
